(19) United States
(12) Patent Application Publication
(10) Pub. No.: US 2003/0194230 A1
(43) Pub. Date: Oct. 16, 2003

(54) Rotation device with an integral bearing

(75) Inventor: Kazushige Tamura, Yokohama-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/400,800

(22) Filed: Mar. 28, 2003

(30) Foreign Application Priority Data
Apr. 10, 2002 (JP) JP2002-107912

(51) Int. Cl. G03B 17/00

(52) U.S. Cl. 396/427

(57) ABSTRACT

A rotation device with an integral bearing that realizes reduced number of parts, simplified configuration, improved assembility, parts-compatibility, and reduced cost. Rotator holder 12 is secured to base plate 10. Slip ring 13 is provided inside rotator holder 12. Cylinder 12a of rotator holder 12 that encircles slip ring 13 serves as a bearing inner ring. Pan chassis 15 that is integrally formed with bearing outer ring 15a is circumscribed to cylinder 12a via rolling ball 14, and comprises horizontal rotation pan motor 16 and gear train 17.

### BACKGROUND OF THE INVENTION

1. Field of the Invention

The present invention relates to a rotation device with an integral bearing that is for use in various machinery and electronic equipments including surveillance cameras.

2. Description of the Related Art

An example of a conventional rotation device for use in surveillance cameras is shown in U.S. Pat. No. 5,627,616.

FIG. 1 is a perspective view showing an example of a conventional surveillance camera equipped with a rotation device. Pan motor base 101 is secured to, for instance, a housing that is positioned on the back of the ceiling. Slip ring 102 is positioned between the housing and pan motor base 101 to provide electrical connections between an electronic circuit board and a tilt mechanism and a camera. Pan motor 103 is mounted on pan motor base 101, and to the output shaft thereof pulley 104 is secured. Horizontal rotation transmitting timing belt 105 bridges between pulley 104 and pulley 106 secured to the horizontal rotation shaft of slip ring 102. When rotating, the horizontal rotation shaft of pulley produces force in the direction of rotation or of the rotating shaft; bearing 107 receives this force so as to permit smooth rotation of pulley 106.

Tilt motor base 108 has the configuration of a reverse L shape with horizontal and vertical parts, and a horizontal part of these is secured to pulley 106. Tilt motor 109 is fixed to a vertical part of tilt motor holder 108, and to the output shaft thereof pulley 110 is fixed. Vertical rotation transmitting timing belt 111 bridges between pulley 110 and another pulley 112 that is fixed to tilt motor holder 108. When rotating, the vertical rotation shaft of pulley 112 produces force in the direction of rotation or of the rotating shaft; bearing 113 receives this force so as to permit smooth rotation of pulley 112 and camera 114 that is fixed to the vertical rotation shaft thereof. This pan/tilt mechanism (rotation device) is covered with a transparent or semi-transparent dome.

Referring to the surveillance camera of the above configuration, when pan motor 103 rotates, pulley 106 rotates over pulley 104 and timing belt 105, and at the same time, tilt motor base 108 secured to pulley 106 also rotates. As a result, camera 114 rotates in horizontal directions in pan movement. Moreover, when tilt motor 109 rotates, pulley 112 rotates over pulley 110 and timing belt 111. As a result, camera 114 secured to pulley 112 rotates in vertical directions in tilt movement. An image taken by camera 114 is converted into a digital signal and sent to outside monitors through slip ring 102.

Still, with the above conventional camera, with tilt motor 109 that enables camera 114 to rotate in the vertical direction and pan motor 103 that enables the whole to rotate in the horizontal direction, the pan/tilt mechanism (rotation device) that enables camera 114 to rotate horizontally and vertically is configured in an L or a reverse L shape. Moreover, this pan/tilt mechanism (rotation device) is equipped with many installation parts including motors 103 and 109 and other parts (such as motor bases 101 and 108, slip ring 102, pulleys 104, 106, 110, and 112, timing belts 105 and 111, etc.), thereby complicating the configuration. Furthermore, the horizontal rotation shaft of the pan mechanism and the vertical rotation shaft of the tilt mechanism are provided with bearings 107 and 113, respectively. Installing these bearings 107 and 113 makes the configuration of the parts where these bearings 107 and 113 are installed complex, requires parts to fix bearings 107 and 113, and requires work such as gluing to fix bearings 107 and 113. That is, a conventional rotation device (pan/tilt mechanism) for surveillance cameras has many parts, which results in a complex configuration, and the assembility, parts-compatibility, and the cost down thereof have a certain limit.

### SUMMARY OF THE INVENTION

It is therefore one of the primary objects of the present invention to provide a rotation device with an integral bearing that has a reduced number of parts and a simplified configuration and that realizes improved assembility, parts-compatibility, and reduced cost.

According one aspect of the invention, there is provided a rotation device with an integral bearing comprising: a non rotating body, integrally formed with an inner ring or an outer ring of the bearing; and, a rotating body, rotatably mounted to the non rotating body and integrally formed with the inner ring or the outer ring of the bearing, wherein a portion of at least one of the non-rotating body and the rotating body integrally incorporates a mechanism.

According to another aspect of the invention, there is provided a surveillance camera device comprising: a non horizontal rotating body, integrally formed with an inner ring or an outer ring of a first bearing; a horizontal rotating body, rotatably mounted to the non horizontal rotating body and integrally formed with the inner ring or the outer ring of the first bearing; a non vertical rotating body, swingably mounted to the horizontal rotating body and integrally formed with an inner ring or an outer ring of a second bearing; a vertical rotating body, rotatably mounted to the non vertical rotating body and integrally formed with the inner ring and outer ring of the second bearing; and a camera, secured to the vertical rotating body.

### BRIEF DESCRIPTION OF THE DRAWINGS

The above and other objects and features of the invention will appear more fully hereinafter from a consideration of the following description taken in connection with the accompanying drawings wherein examples are illustrated by way of example, in which:

FIG. 1 is a perspective view of a conventional surveillance camera;

FIG. 2 is a configuration diagram showing an example of a surveillance camera comprising a rotation device with an integral bearing according to an embodiment of the present invention;

FIG. 3A is a feature diagram that describes the movement of main chassis of rotation device with an integral bearing according to the embodiment of the invention; and

FIG. 3B is a continuation of FIG. 3B.

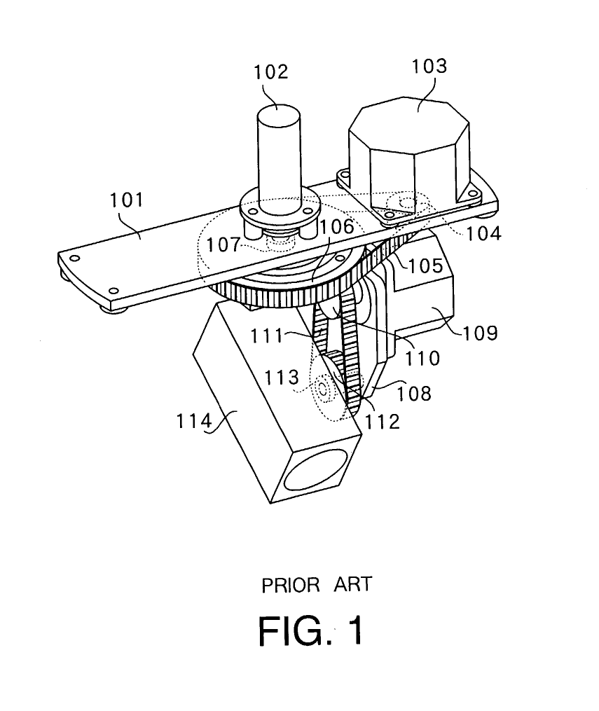

### DESCRIPTION OF THE PREFERRED EMBODIMENT

An embodiment of the present invention will be described below with reference to the accompanying drawings now.

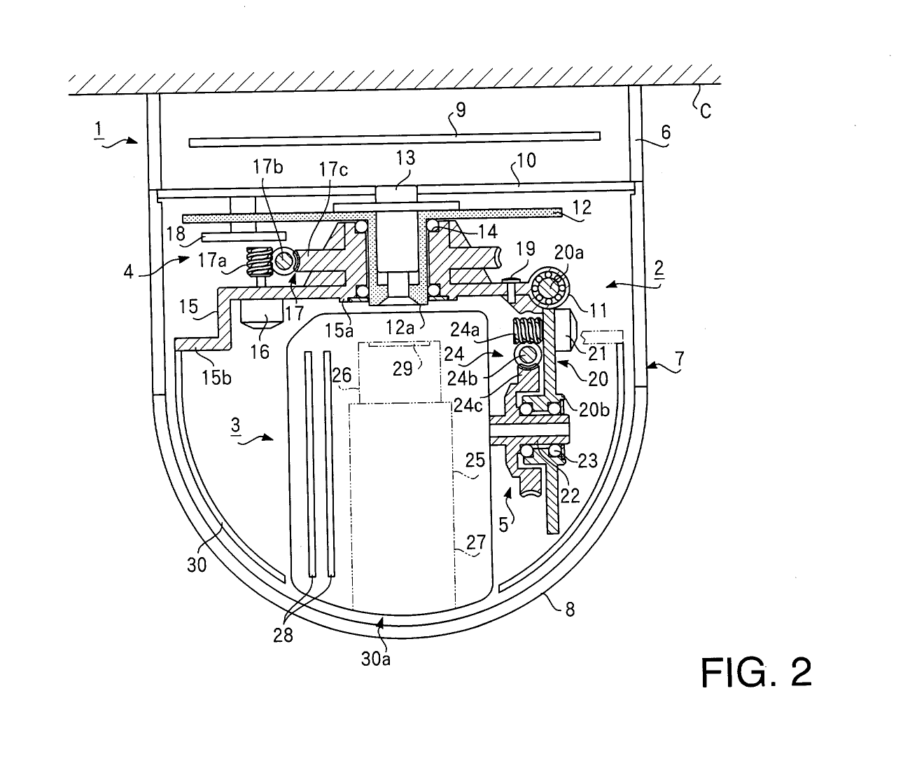

FIG. 2 is a configuration diagram showing an example of a surveillance camera comprising a rotation device with an integral bearing according to an embodiment of the invention. This surveillance camera 1 comprises camera 3 that performs the recording, and rotation device 2 that enables the camera to rotate so as to change the camera's recording direction. Moreover, rotation device 2 consists chiefly of horizontal rotation mechanism 4 and vertical rotation mechanism 5.

Referring to FIG. 2, power source 6 is of a plastic cylinder and secured to ceiling C. Fixer 7 that supports rotation device 2 is of a plastic cylinder and detachably mounted to power source 6. Dome cover 8 is of transparent plastic and secured to fixer 7. These constitute the outer ward of surveillance camera 1. Power circuit board 9 positioned inside power source 6, has a power circuit that is connected to a power source, both not illustrated, and a coaxial cable, not illustrated, for outputting image signals and inputting control signals from the monitors. Fixer 7 and base plate 10 of rotation device 2 are connected, and base plate 10 supports horizontal rotation mechanism 4. Vertical rotation mechanism 5 is rotatably connected to horizontal rotation mechanism 4 via bearing 11, and camera 3 is mounted to vertical rotation mechanism 5.

First, the components of horizontal rotation mechanism 4 will be described.

Rotator holder 12 is secured to base plate 10. Slip ring 13 is provided inside rotator holder 12, and cylinder 12a of rotator holder 12 that encircles slip ring 13 serves as a bearing inner ring. Pan chassis 15 integrated into bearing outer ring 15a is circumscribed to cylinder 12a via rolling ball 14, and comprises horizontal rotation pan motor 16 and gear train 17. Gear train 17 comprises: gear 17a, fixed to the motor shaft of horizontal rotation pan motor 16; intermediate gear 17b, fixed to an intermediate shaft that is at right angles with the motor shaft, and output gear 17c that is at right angles to the motor shaft and integrated with pan chassis 15. Moreover, servo circuit board 18 is secured to rotator holder 12.

Next, the components of vertical rotation mechanism 5 will be described.

Tilt chassis 20 that is integrated with bearing inner ring 20a is secured to pan chassis 15 by means of detachable screw 19. Tilt chassis 20 comprises vertical rotation tilt motor 21 and gear train 24. Gear train 24 consists chiefly of gear 24a secured to a motor shaft of vertical rotation tilt motor 21, and intermediate gear 24b secured to an intermediate shaft that is at right angles with the motor shaft. Bearing outer ring 20b integrated with tilt chassis 20 is attached to tilt shaft 22 that serves as a bearing inner ring via rolling ball 23. Tilt shaft 22 is integrated with output gear 24c that configures gear train 24.

The components of camera 3 will be explained next.

Tilt shaft 22 is secured to lens drive circuit board 25. Lens drive circuit board 25 supports recorder 26 that has CCD (Charge Coupled Diode) and lens section 27 consisting of a plurality of lenses, and has digital circuit board 28 and CCD drive circuit board 29 secured thereto.

Moreover, fixed to support member 15b at an end of pan chassis 15 is inner dome 30 that is smaller than dome cover 8 and is made of semi-transparent or non-transparent plastic. Inner dome 30 has elongated opening 30a for the movement of lens section 27. Power source circuit board 9 and servo circuit board 18 are electrically connected via slip ring 13, while servo circuit 18, CCD drive circuit board 29, digital circuit board 28, and lens drive circuit board 25 are connected by a flex cable.

The operation of a surveillance camera that comprises a rotation device with an integral bearing, having the above configurations, will be described next.

This surveillance camera 1 operates following the programs set in advance by a memory or CPU provided on digital circuit board 28.As horizontal rotation pan motor 16 rotates, pan chassis 15, over gear train 17, rotates around cylinder 12a, and camera 3, over vertical rotation mechanism 5 that is secured to pan chassis 15, rotates horizontally by 360 degrees. Then, vertical rotation tilt motor 21 rotates, and, via gear train 24, tilt shaft 22 rotates, and camera 3 rotates by approximately 90 degrees in the vertical plane from the full horizontal position to the full downward position.

In order for camera 3 to rotate by 180 degrees in the vertical plane, a driving scheme may be employed whereby camera 3 rotates vertically by 180 degrees from the full horizontal position to the full downward position, and thereafter rotates horizontally by 180 degrees and once gain rotates vertically from the full downward position to the full horizontal position. Another driving method may be employed whereby, as vertical rotation tilt motor 21 rotates, camera 3 rotates in the vertical plane by 180 degrees continuously, from a full horizontal position to the counter horizontal position past the full downward position.

Upon every horizontal and vertical rotation, the auto focus function and zoom function that lens drive circuit board 25 is equipped with enables focusing and zooming. An image taken by lens section 27 is converted into an electrical signal in imaging part 26 that is controlled by CCD drive circuit board 29. The electrical signal is converted to a digital signal through digital circuit board 28. The digital signal is sent from servo circuit board 18 to power source circuit board 9 through slip ring 13. The image's digital and control signals are then multiplexed, and sent to an outside monitor through an unillustrated coaxial cable. In the outside monitoring chamber, a person conducts observation by viewing a monitor, and the person is able to perform operation for setting the horizontal and vertical angles of interest and, furthermore able to select the zoom settings of lens section 27.

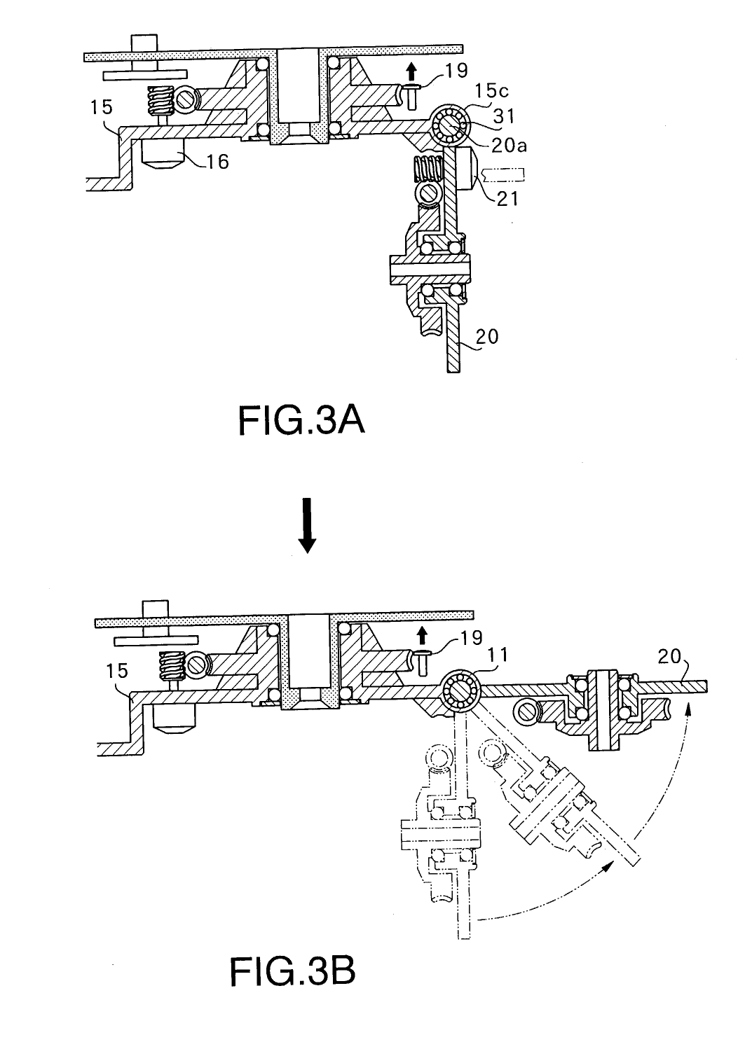

FIG.3A and FIG.3B are feature diagrams that describe the movement of pan chassis 15 and tilt chassis 20, which are the main chassis used in surveillance camera 1. FIG. 3A shows a case where screw 19 that secures pan chassis 15 and tilt chassis 20 at right angles is removed, while FIG. 3B is a diagram wherein pan chassis 15 and tilt chassis 20 are kept horizontally. In these diagrams, both pan chassis 15 and tilt chassis 20 are configured such that they can be integrated with bearing 11.

As shown in FIG. 3A, bearing outer ring 15c that is integrated with pan chassis 15 and bearing inner ring 20a that is integrated with tilt chassis 20 are connected by rolling ball 31. When the surveillance camera is operating, tilt chassis 20 is secured to pan chassis 15 at right angles by screw 19.

Here, as described above, parts including horizontal rotation pan motor 16 are installed to pan chassis 15, and parts including vertical rotation tilt motor 21 are installed to tilt chassis 20. When these required parts are installed, as shown in FIG. 3B, screw 19 can be removed, and with bearing 11 being a supporting point, tilt chassis 20 can be rotated to an angle of interest in relation to pan chassis 15. In actuality, pan chassis 15 and tilt chassis 20 are kept in a horizontal state, so that the parts are installed from the same direction. Moreover, since the both chassis are in a horizontal state, the installation of the parts can be executed from both directions at ease.

Thus, according to the rotation device with an integral bearing according to the present embodiment, inner and outer rings of a bearing are integrated with parts installation platform such as chassis, so that the parts installation platform acquires the functions of a bearing, thereby reducing the number of parts, simplifying the configuration, improving the assembility and parts-compatibility, and reducing the cost.

Moreover, in order to implement both horizontal rotation and vertical rotation in one rotation device, the chassis that serves as the installation platforms for parts for horizontal rotation and vertical rotation may be configured such that each chassis is capable of swinging in relation to the other, so as to improve assembility upon installation of parts and parts compatibility.

Further still, although the above embodiment is a rotation device with an integral bearing for use in surveillance cameras, the use of the present invention is not limited to the above usage and suit for use in various machinery and electronic equipments.

As described above, the present invention realizes reduced number of parts, simplified configuration, improved assembility and parts-compatibility, and reduced cost.

The present invention is not limited to the above described embodiment, and various modifications can be made thereto within the scope the present invention.

The present invention is based on Japanese Patent Application No. 2002-107912 filed on Apr. 10, 2002, the entire content of which is expressly incorporated herein by reference.

What is claimed is:

1. A rotation device with an integral bearing, comprising:
a non-rotating body, integrally formed with an inner ring or an outer ring of the bearing; and
a rotating body, rotatably mounted to the non-rotating body and integrally formed with the outer ring or the inner ring of the bearing, and
wherein a portion of at least one of the non-rotating body and the rotating body integrally incorporates a mechanism.

2. The rotation device with an integral bearing according to claim 1, wherein the mechanism is a driving part that enables rotational movement of the rotating body.

3. The rotation device with an integral bearing according to claim 2, wherein the driving part comprises:
a force generating part that generates rotational force;
a force transmitting part that transmits the generated rotational force to the rotating body,
wherein at least one of the force generating part and the force transmitting part is mounted to the rotating body.

4. A rotation device with an integral bearing, comprising two rotation devices with an integral bearing as claimed in claim 1 as components, wherein the mechanism is a connecting part that connects the two component rotation devices.

5. The rotation device with an integral bearing according to claim 4, wherein the connecting part connects the two component rotation devices in an L or a reverse L shape.

6. The rotation device with an integral bearing according to claim 4, wherein the connecting part rotatably connects the two component rotation devices.

7. The rotation device with an integral bearing according to claim 6, wherein the rotating body of one component rotation device rotates horizontally and the rotating body of the other component rotation device rotates vertically.

8. A surveillance camera device comprising:
a non-horizontal rotating body, integrally formed with an inner ring or an outer ring of a first bearing;
a horizontal rotating body, rotatably mounted to the non-horizontal rotating body and integrally formed with the outer ring or the inner ring of the first bearing;
a non-vertical rotating body, swingably mounted to the horizontal rotating body and integrally formed with an inner ring or an outer ring of a second bearing;
a vertical rotating body, rotatably mounted to the non-vertical rotating body and integrally formed with the outer ring and the inner ring of the second bearing; and
a camera, secured to the vertical rotating body.
